(19) United States
(12) Patent Application Publication
(10) Pub. No.: US 2015/0012852 A1
(43) Pub. Date: Jan. 8, 2015

(54) USER INTERFACE TOOL FOR PLANNING AN AB TYPE OF TEST

(71) Applicant: KOBO Incorporated, Toronto (CA)

(72) Inventors: Talia Borodin, Toronto (CA); Jordan Christensen, Toronto (CA); Darius Braziunas, Toronto (CA)

(21) Appl. No.: 13/936,458

(22) Filed: Jul. 8, 2013

(51) Int. Cl. G06F 11/36

(52) U.S. Cl. CPC G06F 11/3664
USPC 715/762

(57) ABSTRACT

A user inputs values for parameters that are used to plan a test of a second version of an item to be tested that includes a change relative to a first version of the item. The user inputs include a value that defines the size of the group of participants that are to use the second version instead of the first version. Milestones for the test are displayed, along with first information that is determined based on the user-specified inputs and that includes the amount of time needed to reach each of the milestones. Second information that is determined based on the user-specified inputs includes a display of test length versus milestone. The first information and the second information provide a basis for defining the length of the test.

### BACKGROUND

A randomized comparative (or controlled) experiment (or trial), commonly referred to as an AB (or AIB) test, provides a relatively straight-forward way of testing a change to the current design of an item, to determine whether the change has a positive effect or a negative effect on some metric of interest. In an AB test, data is collected for a first design (first version of an item to be tested) and for a second design (second version of the item), where the first and second versions are identical in virtually all respects except for the change being tested.

For example, an AB test can be used to test a change to a Web page before the change is implemented on a more permanent basis, to determine whether the change has a positive or negative effect on, for example, metrics for purchases, account activations, downloads, and whatever else might be of interest. For instance, the color of the “buy” button in one version of the Web page (the current version) may be different from that in another version of the Web page (the changed version), in which case the AB test is designed to test the effect of the button's color on some metric, such as the number of visits that result in a purchase.

While the AB test is being performed, some participants will use the first (current) version of the item being tested while the remaining participants will use the second (changed) version. “Allocation” refers to the percentage of participants that will use the second (changed) version. In a typical AB test, the allocation is 50 percent, meaning half of the participants will use the second version, with the other half using the first version.

During the AB test, data is collected and analyzed to determine the change in a metric of interest associated with the change in the item being tested—the difference (positive or negative) in the value of the metric of interest (e.g., uses that result in purchases) using the first version versus the value for that metric using the second version.

The AB test is preferably planned and executed with statistical rigor to avoid any tendency to pick and choose results that favor one version over the other. There may be a natural variance in the results over time due to factors other than the change itself. For example, results may vary according to the day of the week. Without statistical rigor, a tester might arbitrarily stop the testing once the results appear to favor one version over the other, without considering whether the results would trend the other way if the testing continued. Ideally, the AB test is scheduled to last long enough to get a sample size that is large enough to be statistically valid.

However, the longer the AB test is run, the costlier the test might be. For example, revenue is lost if use of the changed version results in fewer sales during the test period, because users exposed to the changed version did not make a purchase but would have made a purchase if exposed to the unchanged version. In this case, the longer the test is run, the more the revenue that is lost. Thus, when planning an AB test, the planner has to balance the tradeoffs between sample size and hence the length of the test (which determine how small of a percentage change can be detected) and cost: a longer test may be more meaningful, but it may also be more expensive in terms of, for example, lost sales and income.

### SUMMARY

Accordingly, a tool that can allow a test planner to better plan an AB test would be beneficial. More specifically, a tool that can allow a test planner to better identify the criteria for stopping an AB test, considering factors such as cost and sample size (test length), would be beneficial. Embodiments according to the present invention provide such a tool.

In overview, the tool includes different stages: a ramp-up stage, and a tradeoff stage. It may be undesirable to begin an AB test with a 50 percent allocation because, if there is a large undetected bug, for example, it could result in a substantial loss of revenue. For that reason, it is better to start a larger scale AB test with smaller samples of data, and slowly ease into a larger overall allocation. The ramp-up stage addresses this specifically, and is used to identify milestones to check for very large changes in results before increasing the allocation. The tradeoff stage allows the planner to understand the overall time and cost associated with detecting various amounts of change in results. This allows business owners to make informed decisions about how long they will need to run a test (and about the associated cost) to demonstrate whether or not the change in the item being tested is successful.

In one embodiment, the test planning tool includes a graphical user interface (GUI) that allows a user (test planner) to input and manipulate values for certain parameters and that renders outputs that allow the user to quickly plan a test (e.g., an AB test) of a second design (a second version of an item being tested) that includes a change relative to a first design (a first version of the item being tested). The user inputs include a value that defines the allocation the size of the group of participants (e.g., the percentage of participants) that are to use the second version instead of the first version. Test milestones (e.g., different target values for the amount of change in the results that is to be detected during the test) are displayed, along with a first set of information that is determined based on the user-specified inputs and that includes the amount of time needed to reach each of the milestones and the cost associated with reaching each of the milestones. A second set of information that is determined based on the user-specified inputs includes a display (e.g., a graph) of test length versus milestone (percentage change in the metric of interest) and of cost versus milestone (percentage change in the metric of interest). The first information and the second information provide a basis for defining when the test can be stopped (the stop criteria).

The user inputs include historical data that was collected using the first (current) version. The historical data can include, for example, the number of events averaged over a specified unit of time (e.g., the average number of events per day). An event refers to an instance in which the item being tested is “touched” in some manner (e.g., the item being tested is used, accessed, viewed, etc.). The historical data can also include, for example, the percentage of events that result in a specified outcome (e.g., the percentage of uses that result in a purchase), and the average monetary value for each event that resulted in a specified outcome (e.g., the average dollar value per purchase).

The GUI permits the user (test planner) to input different values that define different allocations (e.g., 10 percent, 25 percent, and 50 percent). Information such as the first set of information mentioned above (e.g., the amount of time needed to reach each of the milestones and the cost associated with each of the milestones) can be determined and displayed for each of the allocations. This allows the test planner to ramp up the AB test in a safe way, as mentioned above. For example, the test planner can allocate a smaller percentage of participants to the second (changed) version for a ramp-up period at the beginning of the test, in order to determine whether there is a significant issue (e.g., a bug) associated with the change. Information such as the amount of time needed to reach each of the milestones allows the test planner to determine the length of the ramp-up period, and also allows the test planner to see how long it will take to ramp up to the maximum allocation (e.g., 50 percent).

Information such as test length versus percentage change in the metric of interest and cost versus percentage change in the metric of interest allows the test planner to visualize tradeoffs associated with test length and cost in view of the size of the effect to be detected by the test. For example, to detect smaller changes in a statistically valid way, the sample size needs to be larger, meaning the test needs to run longer, which in turn can increase the potential cost of the testing (e.g., in terms of lost sales). Using information such as test length versus percentage change and cost versus percentage change, the test planner can see, for example, the increases in length and cost of a test to detect a change of about 1.0 percent relative to a test to detect a change of about 1.5 percent. Based on this information, the test planner can determine whether the benefits of detecting a 1.0 percent change versus a 1.5 percent change justify the associated increases in test length and cost. In general, embodiments according to the present invention allow the test planner to make a more informed decision about such matters.

In summary, embodiments according to the present invention can be used to facilitate the process of planning an AB test. The GUI allows test planners to better visualize and understand the tradeoffs between the amount of change to be detected, how long to run the test (which impacts sample size, which in turn affects the statistical validity of the test relative to the amount of change to be detected), and the cost, allowing planners to make better-informed decisions about how to ramp up the test and when to stop the test.

These and other objects and advantages of the various embodiments of the present disclosure will be recognized by those of ordinary skill in the art after reading the following detailed description of the embodiments that are illustrated in the various drawing figures.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1 is a block diagram of an example of a computing system capable of implementing embodiments according to the present disclosure.

FIG. 2 is a flowchart that provides an overview of an AB test process in an embodiment according to the present invention.

FIG. 3 is a block diagram illustrating an example of an AB test in operation in an embodiment according to the present invention.

FIGS. 4 and 5 are examples of GUI elements that can be used to plan an AB test in an embodiment according to the present invention.

FIG. 6 is a flowchart of an example of a computer-implemented method for planning an AB test in an embodiment according to the present invention.

### DETAILED DESCRIPTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computer system. It has proven convenient at times, principally for reasons of common usage, to refer to these signals as transactions, bits, values, elements, symbols, characters, samples, pixels, or the like.

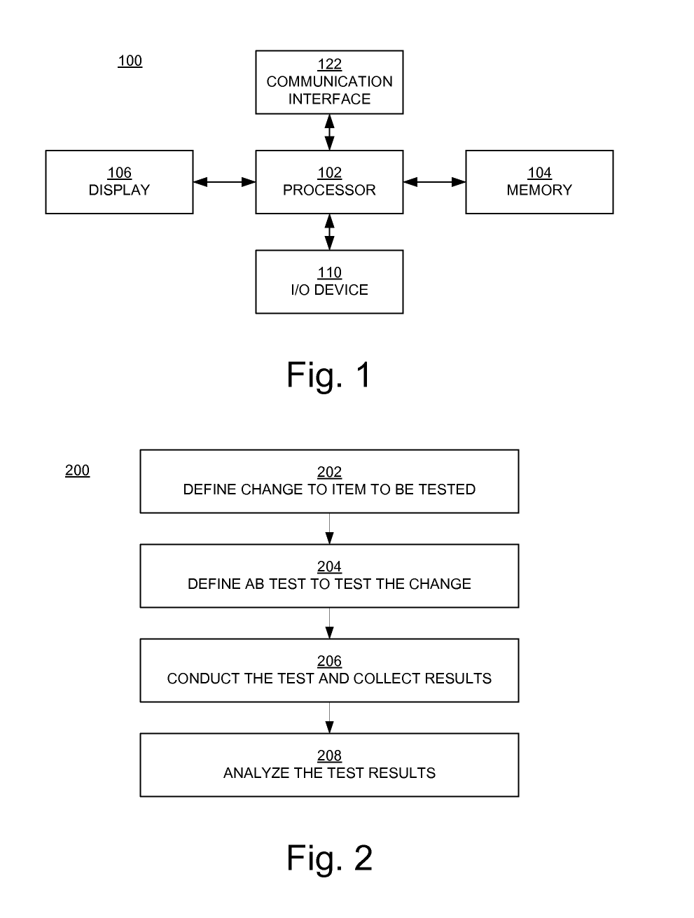

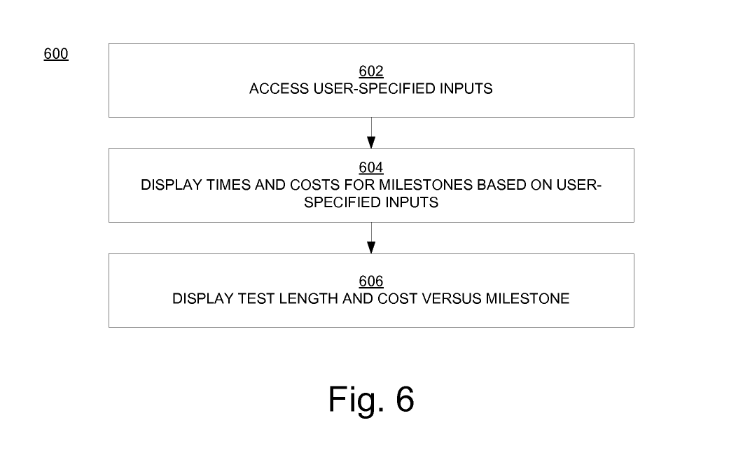

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “accessing,” “displaying,” “rendering,” “receiving,” “determining,” or the like, refer to actions and processes (e.g., the flowchart 600 of FIG. 6) of a computer system or similar electronic computing device or processor (e.g., the computing system 100 of FIG. 1). The computer system or similar electronic computing device manipulates and transforms data represented as physical (electronic) quantities within the computer system memories, registers or other such information storage, transmission or display devices.

Embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer-readable storage media and communication media; non-transitory computer-readable media include all computer-readable media except for a transitory, propagating signal. Generally, program modules include routines, programs, objects, components, data structures, etc., that perform particular tasks or implement particular abstract data types. The functionality of the program modules may be combined or distributed as desired in various embodiments.

Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can accessed to retrieve that information.

Communication media can embody computer-executable instructions, data structures, and program modules, and includes any information delivery media. By way of example, and not limitation, communication media includes wired media such as a wired network or direct-wired connection, and wireless media such as acoustic, radio frequency (RF), infrared, and other wireless media. Combinations of any of the above can also be included within the scope of computer-readable media.

FIG. 1 is a block diagram of an example of a computing system or computing device 100 capable of implementing embodiments according to the present invention. The computing system 100 broadly represents any single or multi-processor computing device or system capable of executing computer-readable instructions. Examples of a computing system 100 include, without limitation, a desktop, laptop, tablet, or handheld computer. Depending on the implementation, the computing system 100 may not include all of the elements shown in FIG. 1, and/or it may include elements in addition to those shown in FIG. 1.

In its most basic configuration, the computing system 100 may include at least one processor 102 and at least one memory 104. The processor 102 generally represents any type or form of processing unit capable of processing data or interpreting and executing instructions. In certain embodiments, the processor 102 may receive instructions from a software application or module. These instructions may cause the processor 102 to perform the functions of one or more of the example embodiments described and/or illustrated herein.

The memory 104 generally represents any type or form of volatile or non-volatile storage device or medium capable of storing data and/or other computer-readable instructions. In certain embodiments, the computing system 100 may include both a volatile memory unit (such as, for example, the memory 104) and a non-volatile storage device (not shown).

The computing system 100 also includes a display device 106 that is operatively coupled to the processor 102. The display device 106 is generally configured to display a graphical user interface (GUI) that provides an easy to use interface between a user and the computing system.

As illustrated in FIG. 1, the computing system 100 may also include at least one input/output (I/O) device 110. The I/O device 110 generally represents any type or form of input device capable of providing/receiving input or output, either computer- or human-generated, to/from the computing system 100. Examples of an I/O device 110 include, without limitation, a keyboard, a pointing or cursor control device (e.g., a mouse), a speech recognition device, or any other input device. The I/O device 110 may also be implemented as a touchscreen that may be integrated with the display device 106.

The communication interface 122 of FIG. 1 broadly represents any type or form of communication device or adapter capable of facilitating communication between the example computing system 100 and one or more additional devices. For example, the communication interface 122 may facilitate communication between the computing system 100 and a private or public network including additional computing systems. Examples of a communication interface 122 include, without limitation, a wired network interface (such as a network interface card), a wireless network interface (such as a wireless network interface card), a modem, and any other suitable interface. In one embodiment, the communication interface 122 provides a direct connection to a remote server via a direct link to a network, such as the Internet. The communication interface 122 may also indirectly provide such a connection through any other suitable connection. The communication interface 122 may also represent a host adapter configured to facilitate communication between the computing system 100 and one or more additional network or storage devices via an external bus or communications channel.

Many other devices or subsystems may be connected to computing system 100. Conversely, all of the components and devices illustrated in FIG. 1 need not be present to practice the embodiments described herein. The devices and subsystems referenced above may also be interconnected in different ways from that shown in FIG. 1. The computing system 100 may also employ any number of software, firmware, and/or hardware configurations. For example, the example embodiments disclosed herein may be encoded as a computer program (also referred to as computer software, software applications, instructions, or computer control logic) on a computer-readable medium.

The computer-readable medium containing the computer program may be loaded into the computing system 100. All or a portion of the computer program stored on the computer-readable medium may then be stored in the memory 104. When executed by the processor 102, instructions loaded into the computing system 100 may cause the processor 102 to perform and/or be a means for performing the operations of the example embodiments described and/or illustrated herein. Additionally or alternatively, the example embodiments described and/or illustrated herein may be implemented in firmware and/or hardware.

In general, in embodiments according to the present invention, the operations are useful for generating a GUI for planning a test (e.g., an AB test) of a first design (a first version of an item being tested) versus a second design (a second version of the item being tested), where the second version includes a change or changes relative to the first version. In one embodiment, the GUI is rendered on the display 106 and includes user-specified inputs of values for parameters of the test. In such an embodiment, the user-specified inputs can include a value that defines a size (allocation) of a group of participants that are to use (access, view, etc.) the second version instead of the first version. In one embodiment, different allocations can be selected by the user (the test planner).

In one embodiment, the GUI can also include “first information” that is based on the user-specified inputs and includes, for example, some number of milestones for the test and times to reach those milestones. The milestones are expressed in terms of the magnitude (e.g., in percent) of the change in a metric of interest. The metric of interest may be a measure of, for example, purchases, account activations, downloads, conversion rates, etc, and may itself be expressed as a percentage (e.g., percentage of accesses that result in a purchase). The first information can also include costs associated with reaching each of the milestones. This type of information can be provided for each allocation specified by the test planner.

In one embodiment, the GUI can also include “second information” that is based on the user-specified inputs and includes, for example, length of the test versus milestone (percent change in results). The second information can also include cost versus milestone (percent change in results). The first information and the second information provide a basis for defining the stop criteria (the length of the test). This type of information can be provided for each allocation specified by the test planner.

Thus, in embodiments according to the present invention, a user (test planner) can input values for basic parameters into the GUI, and receive/view information that allows the user to make informed decisions about how to ease into (ramp up) the test and understand the tradeoffs associated with the amount of change in the metric of interest that the user wants to detect (the milestones) versus the length of the test and the cost of the test.

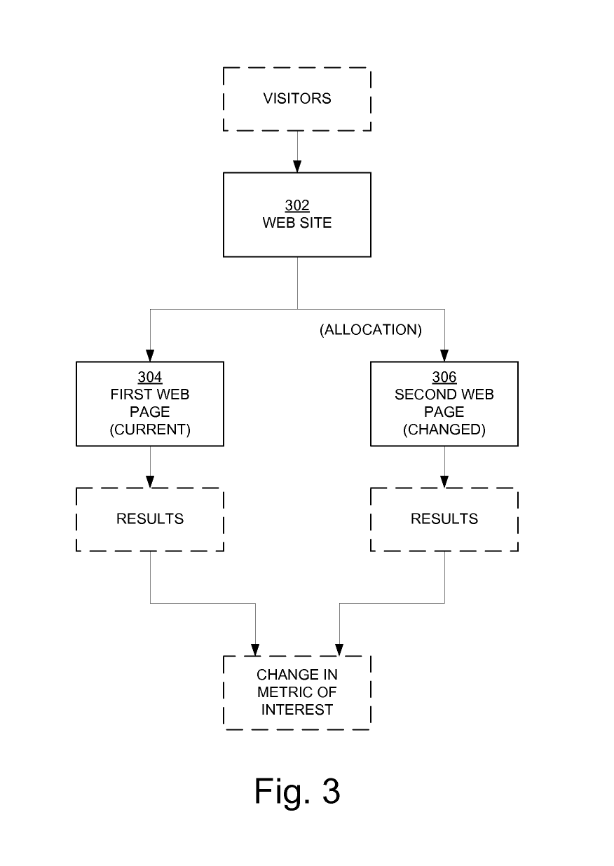

FIG. 2 is a flowchart 200 that provides an overview of an AB test process in an embodiment according to the present invention. In block 202, a potential change to an item to be tested is identified. For example, a client (e.g., a business owner) or Web page designer can identify a potential change to a Web page. However, embodiments according to the invention are not limited to testing changes to Web pages. Other examples of changes that can be tested include, but are not limited to, changes to: hardware features (e.g., features of devices); software features (e.g., features of applications); document or message (e.g., email) content; and document or message (e.g., email) format.

In block 204, a test (e.g., an AB test) is planned, in order to test the change. More specifically, a test that will measure the impact of the change on the metric of interest is planned.

The test may include a ramp-up period that allows the test to be ramped up in a safe (more conservative) way. For example, instead of establishing a 50 percent allocation from the beginning of the test, an allocation of 25 percent may be specified during the ramp-up period. The ramp-up period can be used to detect whether there is a substantial issue with the change (e.g., a bug) before the allocation is increased to 50 percent. In this manner, a change that has a relatively large negative effect can be evaluated and identified early while reducing the impact of the change on the cost of the test (e.g., lost sales).

Stop criteria are also defined for the test, based on tradeoffs between the length and cost of the test versus the amount (e.g., percentage) of change in the metric of interest that the test planner would like to detect.

In block 206, the test is conducted and results are collected. The test is ended when the stop criteria are reached.

In block 208, the test results are analyzed, so that a decision can be made as to whether or not the change to the item being tested should be implemented.

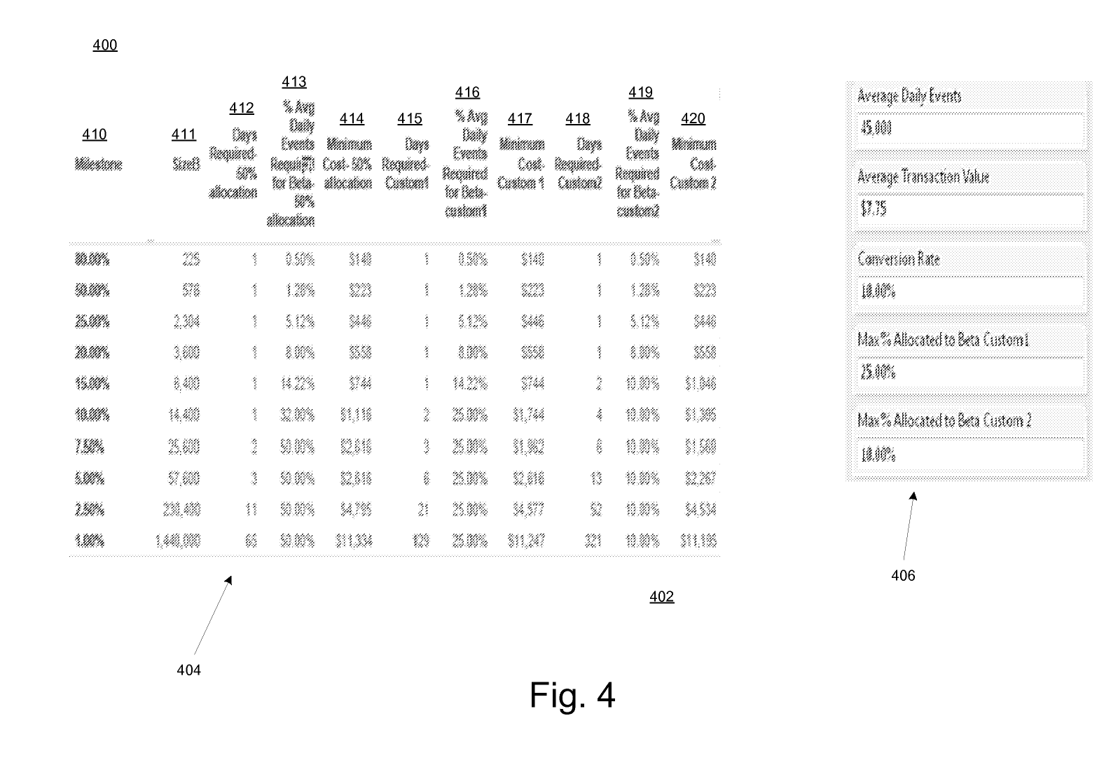

FIG. 3 is a block diagram illustrating an example of an AB test in operation in an embodiment according to the present invention. The example of FIG. 3 pertains to a test of a change to a Web page; however, embodiments according to the present invention are not limited to Web pages, as mentioned above.

In the example of FIG. 3, visitors access a Web site 302 in a conventional manner (e.g., by entering a Uniform Resource Locator (URL) address). The AB test is typically conducted so that it is transparent to the visitors. That is, visitors to the Web site 302 are randomly selected so that they are shown either a first Web page 304 or a second Web page 306, where the second Web page is identical to the first Web page but incorporates one or more changes relative to the first Web page. While random, the process is controlled so that the number of visitors shown the second Web page 306 corresponds to the allocation specified by the test planner. That is, if an allocation of 50 percent is specified, then 50 percent of the visitors will be shown the second Web page 306. As noted above, the allocation can change over time (e.g., there may be a ramp-up period).

Results for each of the Web pages 304 and 306 are collected and analyzed to determine the amount of change to a metric of interest. The metric of interest may be expressed in terms of a binary conversion rate. For example, the metric of interest may be expressed as “buy” versus “did not buy” or “activate” versus “did not activate.” However, the testing is not limited to binary tests, also referred to as Bernoulli trials. The metric of interest could instead be expressed in non-binary terms such as total purchase amounts (e.g., in dollars).

The percent change corresponds to the amount of change in the metric(s) for the Web page 306 relative to the metric(s) for the Web page 304. The percent change may be positive or negative.

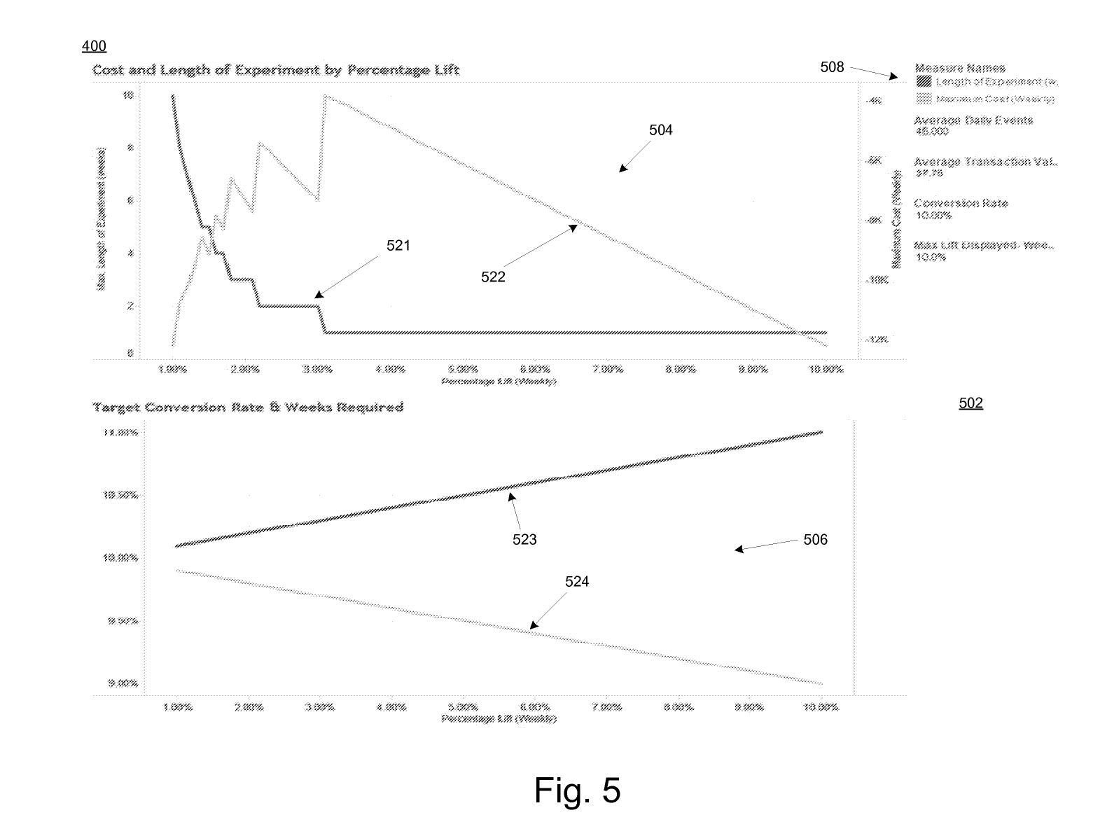

FIG. 4 is an example of a ramp-up element 402 of a GUI 400 that can be used to plan an AB test in an embodiment according to the present invention. The GUI 400 can be displayed on the display device 106 of FIG. 1.

With reference to FIG. 4, the ramp-up element 402 allows a user (test planner) to plan an AB test so that the test of a design change can be rolled out in a gradual manner, if so desired, while checking for relatively large movement in the metric of interest that may be due to a bug, for example. This takes advantage of the fact that a smaller sample size is needed to detect changes of larger magnitude.

In the example of FIG. 4, the ramp-up element 402 includes a tabulated set of values 404 and a set of user-specified inputs 406. The set of values 404 may also be referred to herein as “first information.” The values 404 are determined based on the inputs 406. A change in the inputs 406 is automatically reflected in the values 404. The ramp-up element 402, as well as the set of values 404 and the user-specified inputs 406, may include information in place of or in addition to the information shown in the example of FIG. 4.

The user-specified inputs 406 include values based on historical data that was collected using the first (unchanged) version of the item being tested. For instance, in the example of FIG. 3, the historical data would be based on the first Web page 304, before the AB testing of the second Web page 306 is begun. In the example of FIG. 4, the inputs 406 include values for the following parameters based on historical data: average daily events, average transaction value, and conversion rate. Thus, in the example of FIG. 4, the metric of interest is the conversion rate. Different parameters instead of or in addition to these can be used. The inputs 406 also include two different values for the maximum percentage allocated to “beta” (the percentage of participants that will be directed to use the second version of the item being tested). These two values are in addition to a default value of 50 percent.

The average daily events parameter refers to the average number of daily events expected to eligible for the test, based on historical data. In the example of FIG. 4, the average number of daily events is 45,000. Depending on the allocation, some of those events will be allocated to the second version of the item being tested, and the remainder of those events will be allocated to the first version. Thus, the value for average daily events will directly impact the calculations of test length by taking the sample size required to detect a particular amount (percentage) of change in the metric of interest and spreading the sample size across the average number of daily events. An example of how this input is used is presented below, in the discussion of the set of values 404.

The average transaction value is the average value in dollars per successful conversion (e.g., activation, etc.), based on historical data. A successful conversion refers to an event that is converted to a desired outcome. For example, a successful conversion may be an event that results in a purchase. The average transaction value directly impacts the cost of the test. The average transaction value is used to calculate the opportunity cost of running the test assuming one group is performing worse than the other. In other words, if the second (changed) version has a negative effect on the metric of interest, then the opportunity cost is measured in terms of, for example, purchases not made by participants that used the second version instead of the first (unchanged) version. Similarly, if the second version has a positive effect, then there is an opportunity cost associated with the first version. In the example of FIG. 4, the average transaction value is $7.75. An example of how this input is used is presented below, in the discussion of the set of values 404.

The conversion rate is the percentage of events that result in the desired outcome, based on historical data. For example, the conversion rate may be the number of uses that result in a purchase divided by the total number of uses. The conversion rate is used to calculate a number of subsequent variables such as point increase (conversion rate times percentage change) and statistical variance. In the example of FIG. 4, the conversion rate is 10 percent. An example of how this input is used is presented below, in the discussion of the set of values 404.

With regard to the maximum percentage allocated to beta, in the example of FIG. 4, the user (test planner) can specify up to two values (e.g., 25 percent and 10 percent). A third value of 50 percent is also included automatically. Thus, a user (test planner) can specify different allocations, in order to see how different allocations affect test length and costs. The capability to different allocations also allows the test planner to evaluate strategies for ramping up the test as previously mentioned herein. An example of how these inputs are used is presented below.

As mentioned above, the set of values 404 is determined based on the user-specified inputs 406. In the example of FIG. 4, the set of values 404 includes a number of different milestones 410. The milestones 410 may be default values, or they may be specified by the user (test planner). For example, the user-specified inputs 406 may include fields that allow a user to enter a set of milestones. In the example of FIG. 4, the milestones are expressed as an amount (percentage) of change (positive or negative) in a metric of interest (e.g., conversion rate) as a result of the change to the item being tested.

In the example of FIG. 4, the set of values 404 includes a column 411 named “SizeB.” The size B column 411 refers to the sample size that needs to be allocated to the second (changed) version of the item being tested in order to detect the associated milestone (amount of change in results) given a specified confidence level and power. For example, to detect a change in the results of 80 percent at 95 percent confidence and 80 percent power, the sample size allocated to the second version is 225. For instance, in the example of FIG. 3, for these constraints, 225 visits to the Web page 302 of FIG. 3 are needed to detect a change in the results of 80 percent.

The set of values 404 also can include a column 412 that includes the number of days required to achieve the associated sample size (to detect the corresponding amount of change in the metric of interest) with allocation at 50 percent, based on the number of average daily events included in the user-specified inputs 406. If, for example, the allocation is 50 percent, the average number of daily events is 45,000, and the sample size needed to detect a 7.5 percent change in the results is 25,600, then it will take two days to detect that amount of change: 25,600/(45,000*0.50)=1.14→2 (in this example, the result is rounded up to the next highest integer value).

The set of values 404 also can include a column 413 that includes the percentage of the average daily events required to achieve the associated sample size (to detect the corresponding amount of change in the results) with allocation at 50 percent.

The set of values 404 also can include a column 414 that includes the estimated minimum cost associated with the associated sample size (to detect the corresponding amount of change in the results), based on the conversion rate and average transaction value included in the user-specified inputs 406. If, for example, the conversion rate is 10 percent and the average transaction value is $7.75, then the estimated cost of detecting a change in the results of 80 percent based on a sample size of 225 is: 225*0.1*7.75*0.80≈$140.

In the example of FIG. 4, the set of values 404 also includes columns 415, 416, and 417 that provide the number of days required to achieve the associated sample size (to detect the corresponding amount of change in the metric of interest), the percentage of the average daily events required to achieve the associated sample size, and the estimated minimum cost associated with the associated sample size with allocation at the first of the two allocation values specified by the user in the user-specified inputs 406 (e.g., 25 percent). Similarly, the set of values 404 also includes columns 418, 419, and 420 that provide the number of days required to achieve the associated sample size (to detect the corresponding amount of change in the metric of interest), the percentage of the average daily events required to achieve the associated sample size, and the estimated minimum cost associated with the associated sample size with allocation at the second of the two allocation values specified by the user (test planner) in the user-specified inputs 406 (e.g., 10 percent).

Milestones of 50 percent and 80 percent are very large and, if those amounts of change were detected during the testing, it would likely indicate the presence of a bug or some other type of problem with the change being tested. This type of information can be used to formulate a test strategy that includes a ramp-up period. In other words, in case there is a problem with the proposed change, then it is probably more desirable to limit the allocation at the beginning of the test in order to, for example, reduce the number of lost sales that would occur if a larger number of participants used the second (changed) version. Thus, instead of starting the test at 50 percent allocation, the test planner can decide to start the test at 10 percent allocation and run it at that level for a period of time before increasing the allocation to some other value (e.g., 50 percent). In general, the allocation can be changed over time, and the information in the ramp-up section 402 allows the test planner to make an informed decision about when to change the allocation considering factors such as cost.

With reference to FIG. 5, the GUI 400 also includes a tradeoff element 502 that, along with the ramp-up element 402 of FIG. 4, can be used to plan an AB test in an embodiment according to the present invention. In the example of FIG. 5, the tradeoff element 502 includes a first graph 504 that plots test length versus amount of change in the metric of interest (in percent) and cost versus amount of change in the metric of interest. The graph 504 may be referred to herein as “second information.” The tradeoff element 502 can also include a second graph 506 that plots target conversion rate versus time. The tradeoff element 502 can also include user-specified inputs 508.

In the example of FIG. 5, the tradeoff element 502 is based on an allocation of 50 percent. However, a similar GUI element can be presented for each of the allocation values specified by the user (test planner) in the user-specified inputs 406 of FIG. 4.

In the example of FIG. 5, the user-specified inputs 508 include average daily events, average transaction value, and conversion rate. These fields can be auto-filled using the values that are input into the user-specified inputs 406 of FIG. 4. The user-specified inputs 508 can also include a value for the maximum amount of change in the results that are displayed. This value adjusts the scale of the x-axis of the graphs 504 and 506, to improve visibility of the information presented in those graphs. In FIG. 5, a value of 10 percent is used, which automatically sets the largest value in the x-axis at 10 percent. That maximum value is divided by 10 to give 10 equally sized bins at one percent increments, as shown. If the test planner was trying to detect a smaller amount of change in the results, then he/she could decrease this value to, for example, five percent, which would make the maximum value five percent at increments of 0.5 percent. If the test planner was trying to detect a larger amount of change in the results, then he/she could increase this value to 20 percent, for example, which would make the maximum value 20 percent at increments of two percent.

The graph 504 shows the tradeoffs between the size of the change in results (in the metric of interest) to be detected versus the length and the cost of the test. The line 521 in the graph 504 corresponds to the left axis of the graph, and indicates the length in weeks that the test would need to run in order to achieve the levels of change shown on the x-axis. In this example, time is measured in weeks because, generally speaking, it is better to run tests in week-long increments to avoid day-of-the-week effects. Increments other than weeks can be used in the GUI 400.

The line 522 in the graph 504 shows the approximate cost of the test based on the values in the user-specified inputs 508. In this example, to detect a one percent change in results, the test length is 10 weeks and will cost, at most, approximately $12,000. Note that, to detect a change in the metric of interest of about 1.4 percent, the test length can be reduced to about five weeks and the maximum cost is reduced to about $9,000. Hence, the graph 504 allows the test planner to visualize the tradeoffs between test length, test cost, and the amount of change in the results that can be detected. Thus, for instance, the test planner might decide that, instead of detecting a change of one percent, detecting a change of 1.4 percent is satisfactory given the reductions in both test length and cost. The lines 521 and 522 can be displayed using different colors, for example, to improve visibility.

In the example of FIG. 5, the lines 523 and 524 on the graph 506 show the range of conversion rate that can be detected with the test. Anything between the lines 523 and 524 is statistically equivalent, and anything outside those lines is detectible. In the example of FIG. 5, the graph 506 shows that, to detect a one percent change in the results, the testing is seeking to detect conversion rates higher than 10.1 percent (10 percent plus one percent) or lower than 9.9 percent (10 percent minus one percent).

The information in the GUI 400 of FIGS. 4 and 5 can be used to specify the stop criteria for the AB test. For example, using the information in the graph 504 and/or in the set of values 404, a test planner can make an informed decision as to how long the test should be run, based on cost and the level of change in the results that can be detected. Alternatively, the test planer can select a level of change in the results that the planner wants to detect, and will be able to identify when to stop the test. In general, the stop criteria is grounded in statistical rigor, meaning that the test can be defined to run until the results are statistically valid, rather than running the test for some relatively arbitrary period of time that may or may not yield statistically meaningful results.

FIG. 6 is a flowchart 600 of an example of a computer-implemented method for planning a test (e.g., an AB test) of a second version of an item to be tested that includes a change relative to a first version of that item, in an embodiment according to the present invention. The flowchart 600 can be implemented as computer-executable instructions residing on some form of computer-readable storage medium (e.g., using the computing system 100 of FIG. 1).

In block 602 of FIG. 6, user-specified inputs that include values for parameters of the test are accessed. The user-specified inputs include a value that defines a size of a group of participants (an allocation) that are to use the second version instead of the first version.

In block 604, first information is displayed for milestones (different values for the amount of change in the metric of interest) for the test. The first information includes times to reach the milestones and is determined based on the user-specified inputs. The first information can also include the costs associated with reaching the milestones.

In block 606, second information is also displayed. The second information includes length of the test versus milestone (percent change in the metric of interest) and is based on the user-specified inputs. The second information can also include cost versus milestone (percent change in the metric of interest). The first information and the second information provide a basis for defining the length of the test.

In summary, embodiments according to the present invention provide a tool and GUI that allow test planners to make better-informed decisions with regard to how to plan an AB test. The planner can directly interact with (specify and change values for) certain parameters using the GUI, and the tool automatically generates and displays information in the GUI based on the planner's inputs. The tool and GUI offer quick feedback, allowing the planner to formulate and evaluate different test strategies. Consequently, the tool can reduce the time needed to plan meaningful AB tests and remove guess work that can plague such tests.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. These software modules may configure a computing system to perform one or more of the example embodiments disclosed herein. One or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface. Various functions described herein may be provided through a remote desktop environment or any other cloud-based computing environment.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

Embodiments according to the invention are thus described. While the present disclosure has been described in particular embodiments, it should be appreciated that the invention should not be construed as limited by such embodiments, but rather construed according to the below claims.

What is claimed is:

1. A computer-readable storage medium having computer-executable instructions that, when executed, cause a computing system to perform a method for planning a test of a second version of an item that includes a change relative to a first version of the item, the method comprising:
accessing user-specified inputs comprising values for parameters of the test, the user-specified inputs comprising a value that defines a size of a group of participants that are to use the second version instead of the first version;
displaying, for a plurality of milestones for the test, first information comprising times to reach the milestones, the first information determined based on the user-specified inputs, the milestones comprising different values for an amount of change to a metric associated with the change to the item; and
displaying second information comprising length of the test versus amount of change to the metric, the second information determined based on the user-specified inputs; wherein the first information and the second information provide a basis for defining a length of the test.

2. The computer-readable storage medium of claim 1 wherein the first information further comprises costs associated with reaching the milestones and wherein the second information further comprises cost versus amount of change to the metric.

3. The computer-readable storage medium of claim 1 wherein the user-specified inputs comprise a value based on historical data that was collected using the first version.

4. The computer-readable storage medium of claim 3 wherein the historical data is selected from the group consisting of: number of events associated with the first version averaged over a specified unit of time; percentage of events associated with the first version that result in a specified outcome; and average monetary value of purchases associated with use of the first version.

5. The computer-readable storage medium of claim 1 wherein the user-specified inputs comprise values that define a plurality of different sizes for the group of participants.

6. The computer-readable storage medium of claim 1 wherein the first information further comprises numbers of uses of the second version to reach the milestones.

7. The computer-readable storage medium of claim 1 wherein the user-specified inputs comprise a value that defines a scale for displaying the second information.

8. A system comprising:
a processor;
a display coupled to the processor; and
memory coupled to the processor, the memory have stored therein instructions that, if executed by the system, cause the system to execute a method of planning an AB test of a change to an item being tested, the method comprising:
receiving user-specified inputs comprising values for parameters of the AB test, the user-specified inputs comprising different values that define sizes of groups of participants that are to use a second version of the item instead of a first version of the item, wherein the first version does not include the change to the item and the second version includes the change to the item;
displaying, for a plurality of milestones for the AB test, first information comprising times to reach the milestones, wherein the first information is determined based on the user-specified inputs and wherein the milestones comprise different values for an amount of change to a metric associated with the change to the item; and
displaying second information comprising length of the AB test versus the milestones, wherein the second information is determined based on the user-specified inputs; wherein the first information and the second information provide a basis for defining a length of the AB test.

9. The system of claim 8 wherein the first information further comprises costs associated with reaching the milestones and wherein the second information further comprises cost versus the milestones.

10. The system of claim 8 wherein the user-specified inputs comprise a value based on historical data that was collected using the first version.

11. The system of claim 10 wherein the historical data is selected from the group consisting of: number of events associated with the first version averaged over a specified unit of time; percentage of events associated with the first version that result in a specified outcome; and average monetary value of purchases associated with use of the first version.

12. The system of claim 8 wherein the first information further comprises numbers of uses of the second version that are needed to reach the milestones.

13. The system of claim 8 wherein the user-specified inputs comprise a value that defines a scale for displaying the second information.

14. A system comprising:
a processor;
a display coupled to the processor; and
memory coupled to the processor, the memory have stored therein instructions that, if executed by the system, cause the system to execute operations that generate a graphical user interface (GUI) for planning a test of a second version of an item to be tested that includes a change relative to a first version of the item, the GUI rendered on the display and comprising:
user-specified inputs comprising values for parameters of the test, the user-specified inputs comprising a value that defines a size of a group of participants that are to use the second version instead of the first version;
first information comprising a plurality of milestones for the test and times to reach the milestones, the first information determined based on the user-specified inputs, the milestones comprising different values for an amount of change to a metric associated with the change to the item; and
second information comprising length of the test versus amount of change to the metric, the second information determined based on the user-specified inputs;
wherein the first information and the second information provide a basis for defining a length of the test.

15. The system of claim 14 wherein the first information further comprises costs associated with reaching the milestones and wherein the second information further comprises cost versus amount of change to the metric.

16. The system of claim 14 wherein the user-specified inputs comprise a value based on historical data that was collected using the first version.

17. The system of claim 16 wherein the historical data is selected from the group consisting of: number of events associated with the first version averaged over a specified unit of time; percentage of events associated with the first version that result in a specified outcome; and average monetary value of purchases associated with use of the first version.

18. The system of claim 14 wherein the user-specified inputs comprise values that define a plurality of different sizes for the group of participants.

19. The system of claim 14 wherein the first information further comprises numbers of accesses to the second version to reach the milestones.

20. The system of claim 14 wherein the user-specified inputs comprise a value that defines a scale for displaying the second information.
